(19) United States
(12) Patent Application Publication
(10) Pub. No.: US 2008/0154994 A1
(43) Pub. Date: Jun. 26, 2008

(54) Managing aged index data for a database

(75) Inventors: Martin P. Fischer, Heidelberg (DE); Gernot Kuhr, Heidelberg (DE); Olaf Schmidt, Walldorf (DE); Bernhard Brinkmoeller, Wiesloch (DE)

Correspondence Address: FISH & RICHARDSON, P.C., PO BOX 1022, MINNEAPOLIS, MN, 55440-1022, US

(73) Assignee: SAP AG, Walldorf (DE)

(21) Appl. No.: 11/644,201

(22) Filed: Dec. 22, 2006

(51) Int. Cl. G06F 12/02

(52) U.S. Cl. 707/206; 707/E17.005

(57) ABSTRACT

Index data is maintained in a first index of current data objects and in a second index of aged data objects. A database management system may categorize data objects as either current or aged based either on processes associated with the data objects or based upon time. The database management system may later re-categorizing the data object to reflect changes in processes or time. The database management system may receive a query for data and first search the index of current data objects, then search the index of aged data objects.

### TECHNICAL FIELD

This disclosure relates to data management and, more particularly, to computer systems, methods, and software for implementing or otherwise managing aged index data for a database.

### BACKGROUND

In computerized database management systems, indexes are often used to make database searches quicker and more efficient. For example, one index might include an index entry for each data object of a database. Each individual index entry typically includes some information about the data objects of the database, as well as information for accessing, retrieving, or otherwise identifying the respective data object, such as a pointer to the data object. In this manner, rather than directly searching through the database—which could be quite large—a database management system can search through the index, which is typically much smaller than the database. When the database management system finds relevant data in the index, it can then access the corresponding data object in the database, for example, using a pointer to the data object. The index is typically managed in a hierarchical storage system. That is, portions of the index may be located on hard disk, in cache memory, in main memory, and the like. When the database management system searches the index, it typically transfers portions of the index from hard disk to main memory. Rather than individually transferring indexes one-by-one, the database management system typically transfers entire blocks of the index, which include multiple individual indexes.

Certain database management systems may transfer indexes in the block to main memory that are aged and, further, may not be relevant. In such cases, the database management system may waste time and resources transferring non-relevant indexes from hard disk to main memory. Indeed, over time—as more data is stored and indexed—the problem can become worse.

### SUMMARY

The disclosure provides various embodiments of systems, methods, and software for managing aged index data for a database. For example, a method for managing index data for a database includes maintaining a first index of current data objects and maintaining a second index of aged data objects. In one aspect of the disclosure, a database management system may categorize data objects as either current or aged and index the data objects accordingly into either the index of current data objects or the index of aged data objects. The database management system may categorize a data object as current if the data object is related to a pending business process and may categorize the data object as aged if the data object is related to a closed business process. In other words, the aged indexing may be temporally based, business logic based, or based on any other suitable categorization.

In some cases, the database management system may categorize a data object as current and then re-categorize the data object as aged at some later time. If the data object is re-categorized as aged, the database management system may transfer the individual index of the re-categorized data object from the index of current data objects to the index of aged data objects.

In another example, the database management system may receive a query for data, first search the index of current data objects based on the query, and then search the index of aged data objects based on the query. The query may include a parameter representing a request to search the index of current data objects, to search the index of aged objects, and to search both indexes. In another embodiment of the disclosure, the database management system may create sub-queries for each of the indexes and aggregate responses from the sub-queries before sending a response to a client.

Each of the foregoing—as well as other disclosed—example methods may be computer implementable. Moreover some or all of these aspects may be further included in respective systems and software for managing aged index data for a database. The details of these and other aspects and embodiments of the disclosure are set forth in the accompanying drawings and the description below. Features, objects, and advantages of the various embodiments will be apparent from the description and drawings, and from the claims.

### DESCRIPTION OF DRAWINGS

FIG. 1 illustrates a database environment implementing or managing aged index data for a database in accordance with an embodiment of the present disclosure;

FIG. 2 illustrates a more detailed configuration of the database management system of FIG. 1; and

FIG. 3 illustrates an example method for managing aged index data for a database in accordance with an embodiment of the present disclosure.

### DETAILED DESCRIPTION

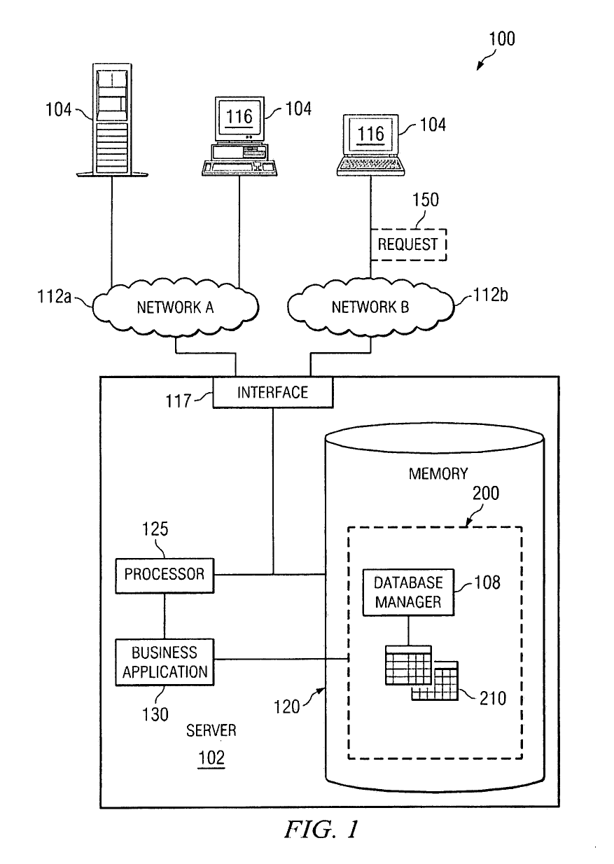

FIG. 1 illustrates a database environment 100 for implementing or managing aged index data in at least a portion of enterprise or data processing environment. At a high level, data environment 100 can implement techniques that may define categories (e.g. priorities) for index-repositories and distribute index-data over several separated index-repositories. This index data is generally managed in a hierarchical organized storage-system (main memory, cache, hard disc, database, and so forth). One example for this could be to define two repositories, one for current data related to still pending business processes and the other one for outdated data (such as closed business processes). In this example, environment 100 may intelligently identify portions of current and portions aged data for this logical separation, while leaving other portions in the original index under various circumstances. When appropriate, the index-data can be accessed via appropriate interface and merged, such as reporting on current and historical transactions. In some cases, there might be no decrease of performance when accessing current business data. Environment 100 may be a distributed client/server system that allows clients 104 to submit requests to store and/or retrieve information from database 210 maintained on server 102. But environment 100 may also be a standalone computing environment or any other suitable environment, such as an administrator accessing data stored on server 102, without departing from the scope of this disclosure.

In the illustrated embodiment, server 102 includes memory 120 and processor 125 and comprises an electronic computing device operable to receive, transmit, process and store data associated with environment 100. For example, server 102 may be any computer or processing device such as a mainframe, a blade server, general-purpose personal computer (PC), Macintosh, workstation, Unix-based computer, or any other suitable device. Generally, FIG. 1 provides merely one example of computers that may be used with the disclosure. In other words, the present disclosure contemplates computers other than general purpose computers as well as computers without conventional operating systems. As used in this document, the term “computer” is intended to encompass a personal computer, workstation, network computer, or any other suitable processing device. For example, although FIG. 1 illustrates one server 102 that may be used with the disclosure, environment 100 can be implemented using computers other than servers, as well as a server pool. Server 102 may be adapted to execute any operating system 110 including z/OS, Linux-Intel or Linux/390, UNIX, Windows Server, or any other suitable operating system. According to one embodiment, server 102 may also include or be communicably coupled with a web server and/or an SMTP server.

Memory 120 may include any memory or database module and may take the form of volatile or non-volatile memory including, without limitation, magnetic media, optical media, random access memory (RAM), read-only memory (ROM), removable media, or any other suitable local or remote memory component. In this embodiment, illustrated memory 120 includes database 210. When the database is stored in relational format, environment 100 may allow access to database 210 using a structured query language (SQL), which may include any of the plurality of versions of the SQL relational database query and manipulation language such as, for example, SEQUEL, ANSI SQL, any other proprietary or public variant of SQL, or other suitable or generic query language (such as eXtensible Markup Language (XML)). Database 210 may include or be communicably coupled with a database manager 108, which is generally any set of logical instructions executed by processor 125 to perform tasks associated with database management and/or responding to queries, including storing information in memory 120, searching database 210, generating responses to queries using information in database 210, and numerous other related tasks. In particular embodiments, database manager 108 accesses database tables 210 in response to queries from clients 104.

Generally, database manager 108 is typically software that manages database 210, including its respective indices and tables. For example, database management system 108 may be any database management software such as, a relational database management system, a database management system using flat files or CSV files, an Oracle® database, a structured query language (SQL) database, a Sybase® database, and the like. As used herein, software generally includes any appropriate combination of software, firmware, hardware, and/or other logic. For example, database manager 108 may be written or described in any appropriate computer language including, for example, C, C++, Java, Visual Basic, assembler, Perl, ABAP, any suitable version of 4 GL, or any combination thereof. It will be understood that while database manager 108 is illustrated in FIG. 1 as a single multi-tasked module, the features and functionality performed by this engine may be performed by multiple modules such as, for example, one or more agents or database instances. Further, while illustrated as internal to server 102, one or more processes associated with database manager 108 may be stored, referenced, or executed remotely. Moreover, database manager 108 may be a child or sub-module of another software module (such as database 210) without departing from the scope of this disclosure. In one embodiment, update module 170 may be referenced by or communicably coupled with applications executing on or presented to client 104.

Server 102 also includes processor 125, which executes instructions (such as the logic or software described above) and manipulates data to perform the operations of server 102 such as, for example, a central processing unit (CPU), a blade, an application specific integrated circuit (ASIC), or a field-programmable gate array (FPGA). In particular, processor 125 performs any suitable tasks associated with database manager 108. Although FIG. 1 illustrates a single processor 125 in server 102, multiple processors 125 may be used according to particular needs and reference to processor 125 is meant to include multiple processors 125 where applicable.

Server 102 may also include or reference a local, distributed, or hosted business application 130. In certain embodiments, business application 130 may request access to retrieve, modify, delete, or otherwise manage the information of one or more databases 200 in memory 120. Specifically, business application 130 may use update module 170 to update data records stored in the database tables 210 as requested by the user and/or application. Business application 130 may be considered business software or solution that is capable of interacting or integrating with databases 200 located, for example, in memory 120 to provide access to data for personal or business use. An example business application 130 may be a computer application for performing any suitable business process or logic by implementing or executing a plurality of steps. Business application 130 may also provide the user, such as an administrator, with computer implementable techniques that can result in the management of aged indexes.

Server 102 may also include interface 117 for communicating with other computer systems, such as client 104, over network 112 in a client-server or other distributed environment. In certain embodiments, server 102 receives requests 150 for data access from local or remote senders through interface 117 for storage in memory 120 and/or processing by processor 125. Generally, interface 117 comprises logic encoded in software and/or hardware in a suitable combination and operable to communicate with network 112. More specifically, interface 117 may comprise software supporting one or more communications protocols associated with communications network 112 or hardware operable to communicate physical signals.

Network 112 facilitates wireless or wireline communication between computer server 102 and any other local or remote computer, such as clients 104. Indeed, while illustrated as two networks, 112a and 112b respectively, network 112 may be a continuous network without departing from the scope of this disclosure, so long as at least portion of network 112 may facilitate communications between senders and recipients of requests 150 and results. In other words, network 112 encompasses any internal and/or external network, networks, sub-network, or combination thereof operable to facilitate communications between various computing components in environment 100. Network 112 may communicate, for example, Internet Protocol (IP) packets, Frame Relay frames, Asynchronous Transfer Mode (ATM) cells, voice, video, data, and other suitable information between network addresses. Network 112 may include one or more local area networks (LANs), radio access networks (RANs), metropolitan area networks (MANs), wide area networks (WANs), all or a portion of the global computer network known as the Internet, and/or any other communication system or systems at one or more locations.

Client 104 is any local or remote computing device operable to receive requests from the user via a user interface 116, such as a GUI, a CLI (Command Line Interface), or any of numerous other user interfaces. Thus, where reference is made to a particular interface, it should be understood that any other user interface may be substituted in its place. In various embodiments, each client 104 includes at least GUI 116 and comprises an electronic computing device operable to receive, transmit, process and store any appropriate data associated with environment 100. It will be understood that there may be any number of clients 104 communicably coupled to server 102. For example, illustrated clients 104 include one local client 104 and two clients external to the illustrated portion of enterprise 100. Further, “client 104” and “user” may be used interchangeably as appropriate without departing from the scope of this disclosure. Moreover, for ease of illustration, each client 104 is described in terms of being used by one user. But this disclosure contemplates that many users may use one computer or that one user may use multiple computers to submit or review queries via GUI 116. As used in this disclosure, client 104 is intended to encompass a personal computer, touch screen terminal, workstation, network computer, kiosk, wireless data port, wireless or wireline phone, personal data assistant (PDA), one or more processors within these or other devices, or any other suitable processing device. For example, client 104 may comprise a computer that includes an input device, such as a keypad, touch screen, mouse, or other device that can accept information, and an output device that conveys information associated with the operation of server 102 or clients 104, including digital data, visual information, or GUI 116. Both the input device and output device may include fixed or removable storage media such as a magnetic computer disk, CD-ROM, or other suitable media to both receive input from and provide output to users of clients 104 through the display, namely GUI 116.

GUI 116 comprises a graphical user interface operable to allow the user of client 104 to interface with at least a portion of environment 100 for any suitable purpose. Generally, GUI 116 provides the user of client 104 with an efficient and user-friendly presentation of data provided by or communicated within environment 100. GUI 116 may provide access to the front-end of business application 130 executing on client 104 that is operable to update the data records of database tables 210 using the generic update module 170. In another example, GUI 116 may display output reports such as summary and detailed reports. GUI 116 may comprise a plurality of customizable frames or views having interactive fields, pull-down lists, and buttons operated by the user. In one embodiment, GUI 116 presents information associated with queries 150 and buttons and receives commands from the user of client 104 via one of the input devices. Moreover, it should be understood that the term graphical user interface may be used in the singular or in the plural to describe one or more graphical user interfaces and each of the displays of a particular graphical user interface. Therefore, GUI 116 contemplates any graphical user interface, such as a generic web browser or touch screen, that processes information in environment 100 and efficiently presents the results to the user. Server 102 can accept data from client 104 via the web browser (e.g., Microsoft Internet Explorer or Mozilla Firefox) and return the appropriate HTML or XML responses using network 112. For example, server 102 may receive such an SQL query from client 104 using the web browser and then execute the parsed query to store and/or retrieve information in database 210.

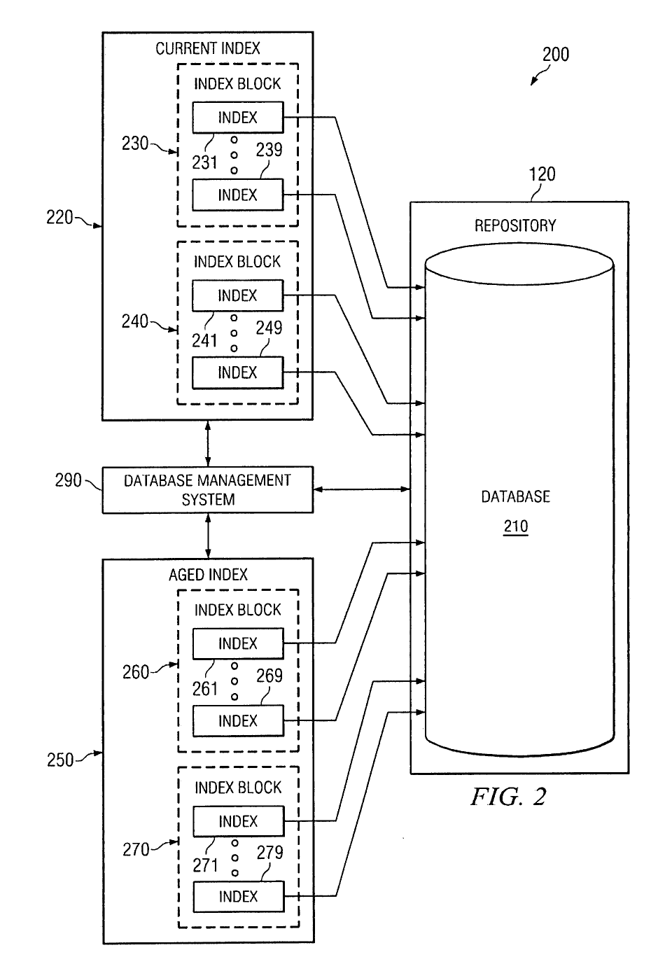

FIG. 2 illustrates an example database system 200 for managing aged index data for a database. In the illustrated embodiment, system 200 includes a repository or memory 120 for database 210, a current index 220 and an aged index 250 (that each include index information for database 210), and a database management system 108 that can be accessed by a variety of clients (not shown), including applications, users, and the like. A user or application client may request data from database management system 108 via a personal computer, server, touch-screen terminal, workstation, network computer, kiosk, wireless data port, smart phone, personal data assistant (PDA), one or more processors within these or other devices, or any other suitable processing device for accessing data.

Repository 120 may be, for example, an intra-enterprise, inter-enterprise, regional, nationwide, or substantially national electronic storage facility, data processing center, archive, hard disk, tape storage, and the like that allows storage of data objects. Repository 120 may include a single or multiple computers, a single or multiple data storage devices, a single or multiple servers, and the like. As such, database 210 may reside on a single device or may be distributed across multiple devices via a network or networks.

Database 210 contains data objects which may be, for example, business data objects (i.e., data objects related to business processes) or other objects. The data objects typically include a key, a type, and one or more attributes. The key may uniquely identifies the data object (or may uniquely identify the data object in combination with the type). The type identifies the type of data object and may be the descriptive name of the data model used for the data object. For example, the type of data object may be “product,” “business partner,” and the like. The attributes are properties or characteristics of the data object. For example, the attributes of a product-type data object may include a product model number, a product price, a product description, and the like. Likewise, the attributes of a business partner-type data object may include the business partner's name, address, phone number, and the like.

Because database 210 may become very large and may be distributed over multiple devices via a network, an index is used to allow quicker and more efficient database searches. The index may include, for example, one individual index for each data object in database 210. Each individual index typically includes some information about the data objects, as well as information for accessing or retrieving those data objects, such as the key and the type of data object. The individual indexes, however, do not include all of the information contained in database 210. For example, the individual indexes typically do not include all of the attributes of each data object and may not include any of the attributes of the data objects. In this manner, rather than directly searching through the entire database 210, database management system 108 can search through the index, which is typically much smaller than database 210. When database management system 108 finds relevant data in the index, it can then access database 210 to retrieve the data object.

The index is typically stored in a hierarchical manner and thus may be located in various devices across a network. For example, the index may be stored in a database, a hard disk, a cache, in main memory, and the like. When database management system 108 searches the index, it may cause an entire block of individual indexes to be copied from a hard disk (or other persistence) to main memory (possibly across a network). Then, database management system 108 reads through the block of individual indexes to search for some particular information. If database management system 108 doesn't find the particular information, it may read another block of individual indexes from hard disk to main memory, and so on until it does find the particular information (or until reaching some threshold for searching).

As noted above in the background section, conventional indexes often include aged data which is typically not relevant to searches being performed by database management system 108. The illustrated embodiment, however, includes two indexes: current index 220 and aged index 250. Current index 220 includes individual indexes for data objects that are categorized as being current. Aged index 220 includes individual indexes for data objects that are categorized as being aged. Data objects may be categorized as being current or aged in a variety of ways, as described in more detail below. While the illustrated embodiment includes two indexes, any number of indexes may be used, as will also be described in more detail below.

As shown in the illustrated embodiment, current index 220 is organized into blocks of individual indexes: index block 230 includes individual indexes 231 through 239 and index block 240 includes individual indexes 241 through 249. Aged index 250 is also organized into blocks of individual indexes: index block 260 includes individual indexes 261 through 269 and index block 270 includes individual indexes 271 through 279. As noted above, database management system 108 typically reads and analyzes the indexes on a block-by-block basis. By having the indexes categorized into current and aged indexes, database management system 108 may search only the current index (e.g., if the query specifies that only the index of current data objects should be searched), may search only the aged index (e.g., if the query specifies that only the index of aged data objects should be searched) and may search the current index before searching the aged index (e.g., if the query does not specify which category of data objects should be searched). In the latter case, database management system 108 may search the current index because it is often more likely that client 104, or business application 130, is requesting a data object that is categorized as current. In this manner, database management system 108 may be able to quickly find a particular data object—often without having to search through non-relevant indexes, or by searching the most likely relevant index (or indexes) first. Moreover, while the illustrative embodiment includes two categories of data objects, database management system 108 may have more than two categories of data objects, and thus may maintain more than two indexes of data objects. These multi-tiered categories and indexes of data objects are described in more detail below.

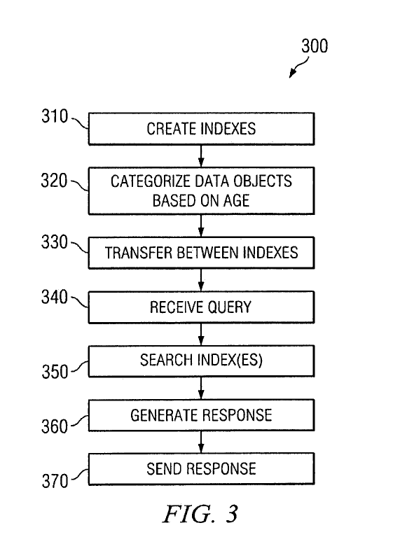

Database management system 108 may perform the functions described below in connection with FIG. 3. FIG. 3 illustrates an example method 300 for managing aged index data for a database. Generally, method 300 describes both maintaining the index data as well as using the index data (e.g., for querying and searching of data objects using the index data).

At step 310, database management system 108 creates indexes. For example, database management system 108 may create two indexes, such as shown in the illustrative system of FIG. 2 or database management system 108 may create any number of indexes, as described in more detail below. The numbers of indexes will typically correspond to the number of categories of data objects as described below in connection with step 320.

At step 320, database management system 108 categorizes data objects based on any suitable business logic or process, such as age. “Age” may be time-based, process status-based, and the like. As an example of a process status-based categorization, database management system 108 may categorize a data object as aged if the data object is related to a closed business process and may categorize a data object as current if the data object is related to a pending business process. For example, a data object that represents an invoice may be categorized as a current data object if the invoice has not been paid and may be categorized as an aged data object if the invoice has been paid and all the associated processing has been completed.

Some data objects may be associated with both pending business processes and closed business processes. In such a case, database management system 108 may categorize the data object as current because at least one business process associated with that data object is still pending (or alternatively, may database management system 108 may categorize the data object as aged). For example, a data object that represents a particular business partner may be associated with both pending and closed invoices. In such a case, the data object may be categorized as a current data object because at least one business process associated with the data object is pending (i.e., the pending invoice). Alternatively, the data object that represents a particular business partner may be categorized based on whether that particular business partner is still a current business partner. Therefore, database management system 108 may categorize different types of data objects based on different process statuses. As such, database management system 108 may include information that defines which business process status or statuses will be used for categorizing each type of data object.

As an example of a time-based categorization, database management system 108 may categorize data objects based on the amount of time since the data object was last accessed (including, for example, read and write operations on the data object). In such a case, database management system 108 may calculate the amount of time, for example, by storing the date of the last access of data objects, then use the date of last access to calculate the amount of time since the data object was last accessed. For example, database management system 108 may categorize a data object as aged if its been more than one week since the data object was last accessed and may categorize the data object as current if its been less than one week since the data object was last accessed. As can be appreciated, any time period may be used by database management system 108.

In another example, database management system 108 may separate the data objects by client context, such as a role of the user or authentication of the session. The data objects would be indexed automatically based on this particular client context categorization. In this example, database management system 108 would generate a first index for the subset of data objects that should be presented or otherwise queried based on satisfactory client context and generate a second index for the second subset of data objects based on unsatisfactory client context. Continuing this example, database management system 108 might identify the particular client context and then determine which of the indexes to use for generation of a new instance of a received query. Say client 104 send a query for journal entries via business application 130 using the original index (or one of the original indexes) known to the business application 130. Database management system 108 may receive, determine, or otherwise identify the client context, such as the user role, authentication status, and so forth. Database management system 108 can then generate a new instance of the journal entry query suitable for the index associated with the identified client context, thereby quickly bypassing the second subset of journal entries.

While the above examples illustrate two-tiered categorizations of data objects (e.g., current and aged categories), multi-tiered categorizations of data objects may also be implemented for either time-based or process status-based categorizations. As an example of a time-based multi-tiered categorization, database management system 108 may categorize data objects into three categories: data objects that have been accessed within the last week, data objects that have been accessed in the last month, and other data objects. As can be appreciated, various time-based categorizations can be implemented. As an example of a process status-based multi-tiered categorization, database management system 108 may categorize data objects into three categories: data objects that are only associated with pending business processes, data objects that are only associated with closed business processes; and data objects that are associated with both closed and pending data processes. As can be appreciated, various process status-based categorizations can be implemented, such as data objects that are associated with only one pending business process and the like. Moreover, various combinations of time-based categorizations and process-status categorizations can be implemented. For example, even if a particular business partner is no longer a current business partner, database management system 108 may not categorize that particular business partner data object as aged until a month later because clients may still query that data object frequently for a short time afterward.

At step 330, database management system 108 transfers an individual index between index categories. At intervals (which are not necessarily regular intervals) or upon initiation by a client, application, user, or the like, database management system 108 evaluates an individual index to determine if the individual index should be re-categorized. For example, in the illustrative system 100 of FIG. 1, database management system 108 may evaluate all, or some, of the individual indexes in current index 220 to determine if any are now associated with closed business process. If database management system 108 determines that an individual index in current index 220 is now associated with a closed business process, database management system 108 may transfer that individual index from current index 220 to aged index 250. Similarly, if database management system 108 determines that an individual index in aged index 250 is associated with a pending business process, database management system 108 may transfer that individual index from aged index 250 to current index 220. The evaluation of individual indexes may be scheduled at off-peak computing times and may evaluate only a portion of the indexes at a time. An application interface may be used to evaluate the individual indexes. The application interface may input the key of the data object and the type of data object and output, or return, the index category using the criteria described above at 220. If the returned index category is different than the current index category, database management system 108 re-categorizes the individual index as described above.

In addition to maintaining the indexes (which may include, for example, creating indexes, categorizing data objects, transferring individual indexes between categories, and the like), database management system 108 may allow clients, applications, users, or the like, to query for data. Thus, at 240, database management system 108 may receive a query for data. The query may be any database query such as one in the form of structured query language (SQL). In addition to the standard SQL parameters, the query received by database management system 108 may also include an additional parameter representing an index category. For example, in the illustrative system 100 of FIG. 1, the additional parameter may represent that database management system 108 should search only the current index, search only the aged index, search both indexes, search the current index first and then the aged index, and the like. For multi-tiered index categories, the additional query parameter may represent that database management system 108 should search a particular index category or categories, search combinations of index categories, search index categories in a particular order, and the like.

At step 350, database management system 108 searches an index or indexes based on the query. Database management system 108 may read the additional query parameter, if implemented, and search an index or indexes based on the additional query parameter. For example, in the two-tiered categorization system 100 of FIG. 3, if the additional query parameter represents that only the current index category should be searched, database management system 108 may search only the current index 220. Alternatively, even if the additional query parameter represents that only the current index category should be searched, database management system 108 may first search the current index 220 and then search the aged index 250 if no matches are found using the current index 220. If the additional query parameter represents that both index categories should be searched, database management system 108 may first search the current index 220 and then search the aged index 250 if, for example, no matches are found using the current index 220.

Similarly for multi-tiered index categories, if the additional query parameter represents that only the most current index category should be searched, then database management system 108 may search only the most current index category. Alternatively, database management system 108 may first search the most-current index category, then search the next most current index category, until reaching the least-current index category.

If no additional query parameter is provided, database management system 108 may search only the current index, may search the current index first and then the aged index, and the like. Similarly for multi-tiered index categories, if no additional query parameter is provided, database management system 108 may search only the most current index category, may search index categories in order of most current to least current, and the like.

As can be appreciated, because database management system 108 may first search the most relevant category, database management system 108 may avoid transferring large blocks of individual indexes from hard disk to main memory. The memory used by database management system 108 may be any memory or database module and may take the form of volatile or non-volatile memory including, without limitation, magnetic media, optical media, random access memory (RAM), read-only memory (ROM), removable media, or any other suitable local or remote memory component.

Database management system 108 may include or create a dispatcher that creates sub-queries for each index category to the searched. For example, if the additional query parameter is implemented in the illustrative system of FIG. 1 and represents that both illustrative index categories should be searched, the dispatcher may create one sub-query for current index 220 and a second sub-query for aged index 250. The dispatcher may also handle error situations which might occur during access to individual index categories.

At 360, database management system 108 generates a response to the query. If database management system 108 searched only one index category, then database management system 108 generates a response in much the same way as a standard database management system. If database management system 108 searched more than one index category, then database management system 108 may aggregate the results from each index category into a single response before sending the response to the client 104 or application 130 at step 370. Database management system 108 may also include a parameter indicating which indexes were searched in its response to the client.

The preceding flowchart and accompanying description illustrate an exemplary method 300. System 100 contemplates using or implementing any suitable technique for performing these and other tasks. It will be understood that these methods are for illustration purposes only and that the described or similar techniques may be performed at any appropriate time, including concurrently, individually, or in combination. In addition, many of the steps in this flowchart may take place simultaneously and/or in different orders than as shown and need not take place at all. Moreover, system 100 may use methods with additional steps, fewer steps, and/or different steps, so long as the methods remain appropriate.

Although this disclosure has been described in terms of certain embodiments and generally associated methods, alterations and permutations of these embodiments and methods will be apparent to those skilled in the art. For example, certain embodiments of system 100 may use a variety of database management systems. In another example, while describe above as generally categorizing the indexes based on age, this disclosure contemplates system 100 separating index-data into any suitable categories including a separation based on authorizations (not every user is allowed to search data based on all indexes), on visibility (some data is not relevant for a particular user-context, thereby bypassing the corresponding indexes during searches), and on many others. Indeed, with respect to the aged indexes, the original index can be separated into different categories of aged data (e.g. 1 month, 3 months, 6 months, 1 year, older than 1 year). By mapping the corresponding indexes onto different storage systems with varying response times and costs, total cost of ownership (TCO) may be potentially reduced. Accordingly, the above description of example embodiments does not define or constrain this disclosure. Other changes, substitutions, and alterations are also possible without departing from the spirit and scope of this disclosure.

What is claimed is:

1. A computer-implemented method for maintaining index data for a database, comprising:
maintaining a first index of current data objects; and
maintaining a second index of aged data objects.

2. The method of claim 1, wherein at least a subset of the data objects are business objects.

3. The method of claim 1 further comprising categorizing an updated data object as one of current and aged.

4. The method of claim 3, wherein categorizing the data object comprises categorizing the data object as current if the data object is related to a pending business process.

5. The method of claim 3, the updated data object comprising a new data object.

6. The method of claim 3, wherein categorizing the data object comprises categorizing the data object as aged if the object has not been accessed for more than a predefined time.

7. The method of claim 1 further comprising:
categorizing a data object as current;
re-categorizing the data object as aged; and
transferring an individual index of the data object from the index of current data objects to the index of aged data objects.

8. The method of claim 1 further comprising:
receiving a query for particular data objects;
searching the index of current data objects based on the query; and
if the query is not satisfied, searching the index of aged data objects based on the query, subsequently to searching the index of current data objects.

9. The method of claim 1 further comprising:
receiving a query for data, the query including a parameter representing a request to search the index of current data objects; and
searching the index of current data objects.

10. The method of claim 1 further comprising:
receiving a query for data, the query including a parameter representing a request to search the index of aged data objects; and
searching the index of aged data objects.

11. The method of claim 1 further comprising:
receiving a query for data;
executing a first sub-query representing a request to search the index of current data objects; and
executing a second sub-query representing a request to search the index of aged data objects.

12. The method of claim 11 further comprising:
retrieving at least one data object using the index of current data objects;
retrieving at least one data object using the index of aged data objects;
aggregating the retrieved data objects; and
sending the aggregated data to the query requester.

13. The method of claim 1, the current data objects and the aged business objects associated with the same database table.

14. A computer-readable medium for maintaining index data for a database, the computer readable medium including computer-readable instructions operable when executed on a processor to:
maintain a first index of current data objects; and
maintain a second index of aged data objects.

15. The computer-readable medium claim 14, wherein the computer-readable instructions are further operable to perform categorize a particular data object as one of current and aged.

16. The computer-readable medium claim 14, wherein the computer-readable instructions further cause the processor to perform:
categorizing a data object as current;
re-categorizing the data object as aged; and
transferring an individual index of the data object from the index of current data objects to the index of aged data objects.

17. The computer-readable medium claim 14, wherein the computer-readable instructions further cause the processor to perform:
receiving a query for data, the query including a parameter representing a request to search the index of current data objects; and
searching the index of current data objects.

18. The computer-readable medium claim 14, wherein the computer-readable instructions further cause the processor to perform:
receiving a query for data;
creating a first sub-query representing a request to search the index of current data objects; and
creating a second sub-query representing a request to search the index of aged data objects.

19. A system for maintaining index data for a database, comprising:
a first index of current data objects;
a second index of aged data objects; and
a database management system operable to:
maintain a first index of current data objects; and
maintain a second index of aged data objects.

20. The system of claim 19, wherein the database management system is further operable to automatically categorize a particular data object as one of current and aged.

21. The system of claim 19, wherein the database management system is further operable to:
categorize a data object as current;
re-categorize the data object as aged based on certain criteria; and
transfer a particular index entry of the data object from the index of current data objects to the index of aged data objects.

22. A computer implemented method for managing aged indexed data comprising:
identifying a plurality of data objects using a first index;
indexing a first subset of the data objects using a second index based on a business categorization of the data objects; and
indexing a second subset of the data objects using a third index based on the business categorization of the data objects.

23. The method of claim 22, the business categorization associated with particular business logic.

24. The method of claim 22 further comprising:
receiving a query for one or more of the data objects, the query associated with the first index and a client context;
executing an instance of the query on the first subset of the data objects using the second index; and
skipping the second subset of the data objects based on the third index and the client context.
